(19) United States
(12) Patent Application Publication
(10) Pub. No.: US 2024/0334207 A1
(43) Pub. Date: Oct. 3, 2024

(54) AMBIENT INTERNET OF THINGS SYSTEM ARCHITECTURE

(71) Applicant: QUALCOMM Incorporated, San Diego, CA (US)

(72) Inventors: Soo Bum LEE, San Diego, CA (US); Haris ZISIMOPOULOS, London (GB); Luis Fernando Brisson LOPES, Swindon (GB); Gavin Bernard HORN, La Jolla, CA (US); Sebastian SPEICHER, Wallisellen (CH)

(21) Appl. No.: 18/604,093

(22) Filed: Mar. 13, 2024

Related U.S. Application Data
(60) Provisional application No. 63/492,475, filed on Mar. 27, 2023.

(51) Int. Cl. H04W 24/02; G16Y 30/00; H04W 4/38

(52) U.S. Cl. CPC H04W 24/02; H04W 4/38; G16Y 30/00

(57) ABSTRACT

Methods, systems, and devices for wireless communications are described. A plurality of public land mobile networks (PLMNs) across the plurality of different mobile network operators (MNOs) may participate in a shared operator service offering for facilitating provision of intelligent services in ambient computing environments. A first network entity, such as a reader device, may receive from an energy harvesting (EH)-capable device in an ambient computing environment a back-scattered signal that includes identification information associated with the EH-capable device. In some cases, the first network entity and the EH-capable device may be associated with different PLMNs or different MNOs. Based on configuration information indicating a type of enrichment information to collect, the first network device may obtain enrichment information associated with the EH-capable device and may cause the identification information and the enrichment information to be transmitted to a second network entity.

### CROSS REFERENCE

The present Application for Patent claims the benefit of U.S. Provisional Patent Application No. 63/492,475 by Lee et al., entitled “AMBIENT INTERNET OF THINGS SYSTEM ARCHITECTURE,” filed Mar. 27, 2023, and assigned to the assignee hereof. U.S. Provisional Patent Application No. 63/492,475 is expressly incorporated by reference herein in its entirety.

### INTRODUCTION

The following relates to wireless communications in ambient computing environments. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support an ambient IoT (AIoT) system architecture. For example, the described techniques provide for a plurality of public land mobile networks (PLMNs) across the plurality of different mobile network operators (MNOs) to participate in a shared operator service offering. The shared operator service offering may allow the plurality of PLMNs to collaborate to enhance coverage for providing intelligent services in ambient computing environments. The ambient computing environment may include one or more wireless devices (e.g., energy harvesting (EH)-capable devices, non-EH-capable devices, battery powered devices, or other wireless devices) that interact with one or more other devices, such as reader devices that may read the wireless devices, to facilitate provision of the intelligent services. The reader devices may in turn communicate with one or more other network devices to facilitate provision of the intelligent services. The shared operator service offering may allow participating PLMNs to leverage such reader devices to collect information and data from the wireless devices in the ambient computing environments. The collected information may be shared to one or more shared data storage areas for later retrieval by a PLMN to whom the collected information belongs.

A method for wireless communications by a first network entity is described. The method may include receiving, from a second network entity, configuration information indicating a type of enrichment information to collect, receiving a back-scattered signal from an EH-capable device, where the back-scattered signal includes identification information associated with the EH-capable device, obtaining, based on the configuration information, enrichment information associated with the EH-capable device, where the enrichment information is separate from the identification information, and causing transmission of the identification information and the enrichment information to the second network entity.

A first network entity for wireless communications is described. The first network entity may include one or more memories storing processor executable code, and one or more processors coupled with the one or more memories. The one or more processors may individually or collectively be operable to execute the code to cause the first network entity to receive, from a second network entity, configuration information indicating a type of enrichment information to collect, receive a back-scattered signal from an EH-capable device, where the back-scattered signal includes identification information associated with the EH-capable device, obtain, based on the configuration information, enrichment information associated with the EH-capable device, where the enrichment information is separate from the identification information, and cause transmission of the identification information and the enrichment information to the second network entity.

Another first network entity for wireless communications is described. The first network entity may include means for receiving, from a second network entity, configuration information indicating a type of enrichment information to collect, means for receiving a back-scattered signal from an EH-capable device, where the back-scattered signal includes identification information associated with the EH-capable device, means for obtaining, based on the configuration information, enrichment information associated with the EH-capable device, where the enrichment information is separate from the identification information, and means for causing transmission of the identification information and the enrichment information to the second network entity.

A non-transitory computer-readable medium storing code for wireless communications is described. The code may include instructions executable by one or more processors to receive, from a second network entity, configuration information indicating a type of enrichment information to collect, receive a back-scattered signal from an EH-capable device, where the back-scattered signal includes identification information associated with the EH-capable device, obtain, based on the configuration information, enrichment information associated with the EH-capable device, where the enrichment information is separate from the identification information, and cause transmission of the identification information and the enrichment information to the second network entity.

In some examples of the method, first network entities, and non-transitory computer-readable medium described herein, obtaining the enrichment information may include operations, features, means, or instructions for receiving the enrichment information via the back-scattered signal.

In some examples of the method, first network entities, and non-transitory computer-readable medium described herein, obtaining the enrichment information may include operations, features, means, or instructions for generating, based on configuration by the second network entity, the enrichment information.

In some examples of the method, first network entities, and non-transitory computer-readable medium described herein, generating the enrichment information may include operations, features, means, or instructions for collecting, using a sensor at the EH-capable device, the enrichment information and the enrichment information includes sensor information.

In some examples of the method, first network entities, and non-transitory computer-readable medium described herein, the enrichment information includes device status information or neighbor cell information.

Some examples of the method, first network entities, and non-transitory computer-readable medium described herein may further include operations, features, means, or instructions for causing transmission of a first signal to the EH-capable device, where the first signal includes an energy signal for energy harvesting, and where the back-scattered signal may be received in response to the first signal.

In some examples of the method, first network entities, and non-transitory computer-readable medium described herein, the first network entity includes a base station, one or more components of a base station, or a UE.

A method for wireless communications by a first network entity is described. The method may include causing transmission of configuration information to one or more second network entities, where the configuration information indicates a type of enrichment information to collect, receiving, from the one or more second network entities, one or more signals including identification information associated with an EH-capable device and enrichment information associated with a service, generating, based on aggregation of the enrichment information received from the one or more second network entities, service information associated with the service, and sending, to a data storage area, the identification information associated with the EH-capable device and the service information associated with the service.

A first network entity for wireless communications is described. The first network entity may include one or more memories storing processor executable code, and one or more processors coupled with the one or more memories. The one or more processors may individually or collectively be operable to execute the code to cause the first network entity to cause transmission of configuration information to one or more second network entities, where the configuration information indicates a type of enrichment information to collect, receive, from the one or more second network entities, one or more signals including identification information associated with an EH-capable device and enrichment information associated with a service, generate, based on aggregation of the enrichment information received from the one or more second network entities, service information associated with the service, and send, to a data storage area, the identification information associated with the EH-capable device and the service information associated with the service.

Another first network entity for wireless communications is described. The first network entity may include means for causing transmission of configuration information to one or more second network entities, where the configuration information indicates a type of enrichment information to collect, means for receiving, from the one or more second network entities, one or more signals including identification information associated with an EH-capable device and enrichment information associated with a service, means for generating, based on aggregation of the enrichment information received from the one or more second network entities, service information associated with the service, and means for sending, to a data storage area, the identification information associated with the EH-capable device and the service information associated with the service.

A non-transitory computer-readable medium storing code for wireless communications is described. The code may include instructions executable by one or more processors to cause transmission of configuration information to one or more second network entities, where the configuration information indicates a type of enrichment information to collect, receive, from the one or more second network entities, one or more signals including identification information associated with an EH-capable device and enrichment information associated with a service, generate, based on aggregation of the enrichment information received from the one or more second network entities, service information associated with the service, and send, to a data storage area, the identification information associated with the EH-capable device and the service information associated with the service.

In some examples of the method, first network entities, and non-transitory computer-readable medium described herein, the data storage area includes a data clearinghouse shared by a set of multiple PLMNs.

In some examples of the method, first network entities, and non-transitory computer-readable medium described herein, the first network entity may be associated with an MNO or a PLMN.

Some examples of the method, first network entities, and non-transitory computer-readable medium described herein may further include operations, features, means, or instructions for receiving, from an application function, a request for information associated with a first EH-capable device, where the request includes identification information associated with the first EH-capable device and sending, to the application function and based on the identification information associated with the first EH-capable device, service information associated with the first EH-capable device.

Some examples of the method, first network entities, and non-transitory computer-readable medium described herein may further include operations, features, means, or instructions for sending, to the application function, a charging record for the service information associated with the first EH-capable device.

Some examples of the method, first network entities, and non-transitory computer-readable medium described herein may further include operations, features, means, or instructions for tagging service information as unclaimed based on a determination that no request for the service information may have been received within a threshold period of time from receipt of the service information from the one or more second network entities.

Some examples of the method, first network entities, and non-transitory computer-readable medium described herein may further include operations, features, means, or instructions for causing unclaimed service information and corresponding identification information to be removed from the data storage area after the threshold period of time.

In some examples of the method, first network entities, and non-transitory computer-readable medium described herein, sending the identification information and the service information to the data storage area may include operations, features, means, or instructions for identifying the data storage area from among a set of multiple data storage areas based at least in part of a type of the service information, routing information associated with the identification information, a location indicated by the service information, a contracted PLMN associated with the data storage area, a service level agreement associated with a PLMN associated with the data storage area, or a combination thereof and sending the identification information and the service information to the identified data storage area.

A method for wireless communications by an EH-capable device is described. The method may include enabling, based on detection of a first signal from a network entity, a service associated with the EH-capable device, obtaining enrichment information associated with the service, and outputting a back-scattered signal including identification information associated with the EH-capable device and the enrichment information.

An EH-capable device for wireless communications is described. The EH-capable device may include one or more memories storing processor executable code, and one or more processors coupled with the one or more memories. The one or more processors may individually or collectively be operable to execute the code to cause the EH-capable device to enable, based on detection of a first signal from a network entity, a service associated with the EH-capable device, obtain enrichment information associated with the service, and output a back-scattered signal including identification information associated with the EH-capable device and the enrichment information.

Another EH-capable device for wireless communications is described. The EH-capable device may include means for enabling, based on detection of a first signal from a network entity, a service associated with the EH-capable device, means for obtaining enrichment information associated with the service, and means for outputting a back-scattered signal including identification information associated with the EH-capable device and the enrichment information.

A non-transitory computer-readable medium storing code for wireless communications is described. The code may include instructions executable by one or more processors to enable, based on detection of a first signal from a network entity, a service associated with the EH-capable device, obtain enrichment information associated with the service, and output a back-scattered signal including identification information associated with the EH-capable device and the enrichment information.

In some examples of the method, EH-capable devices, and non-transitory computer-readable medium described herein, obtaining the enrichment information may include operations, features, means, or instructions for collecting, using a sensor at the EH-capable device, the enrichment information, where the enrichment information includes sensor information, and where the sensor information includes location information or environmental information.

In some examples of the method, EH-capable devices, and non-transitory computer-readable medium described herein, the first signal includes an energy signal received from the network entity for energy harvesting.

In some examples of the method, EH-capable devices, and non-transitory computer-readable medium described herein, the back-scattered signal may be output using radio resources shared across a set of multiple MNOs or dedicated radio resources associated with a first MNO of a set of multiple MNOs.

In some examples of the method, EH-capable devices, and non-transitory computer-readable medium described herein, the EH-capable device includes an RFID tag.

### BRIEF DESCRIPTION OF THE DRAWINGS

FIG. 1 shows an example of a wireless communications system that supports an ambient IoT (AIOT) system architecture in accordance with one or more aspects of the present disclosure.

FIG. 2 shows an example of a wireless communications system that supports an AIoT system architecture in accordance with one or more aspects of the present disclosure.

FIG. 3 shows an example of a wireless communications systems that supports an AIoT system architecture in accordance with one or more aspects of the present disclosure.

FIG. 4 shows an example signal flow that supports an AIoT system architecture in accordance with one or more aspects of the present disclosure.

FIGS. 5 and 6 show block diagrams of devices that support an AIoT system architecture in accordance with one or more aspects of the present disclosure.

FIG. 7 shows a block diagram of a communications manager that supports an AIoT system architecture in accordance with one or more aspects of the present disclosure.

FIG. 8 shows a diagram of a system including a device that supports an AIoT system architecture in accordance with one or more aspects of the present disclosure.

FIGS. 9 and 10 show block diagrams of devices that support an AIoT system architecture in accordance with one or more aspects of the present disclosure.

FIG. 11 shows a block diagram of a communications manager that supports an AIoT system architecture in accordance with one or more aspects of the present disclosure.

FIG. 12 shows a diagram of a system including a device that supports an AIOT system architecture in accordance with one or more aspects of the present disclosure.

FIGS. 13 through 15 show flowcharts illustrating methods that support an AIoT system architecture in accordance with one or more aspects of the present disclosure.

### DETAILED DESCRIPTION

Various aspects of the present disclosure relate to an ambient Internet of Things (AIoT) system architecture. In some implementations, a plurality of public land mobile networks (PLMNs) across the plurality of different mobile network operators (MNOs) may opt to participate in a shared operator service offering. The shared operator service offering may allow the plurality of PLMNs across the plurality of different MNOs to collaborate to enhance coverage for providing intelligent services in ambient computing environments. Such ambient computing environments may utilize connected Internet of Things (IoT) devices to harness information from the surrounding environment and provide intelligent services to users. In some cases, the IoT devices included in the ambient computing environment may include wireless devices, such as energy harvesting (EH)-capable devices (e.g., radio frequency identification (RFID) tags), non-EH-capable devices, battery powered devices, or other wireless devices). The wireless devices may interact with one or more other devices in the ambient computing environment to provide intelligent services to a user. For instance, the wireless devices may interact with a network device, such as a reader device, that may detect or read the wireless device. The reader device may communicate with one or more other network devices to provide the intelligent services. The shared operator service offering may allow participating PLMNs to leverage such reader devices that are associated with the plurality of PLMNs (for example, reader devices associated with a PLMN different from a PLMN associated with a wireless device), to collect information and data from the wireless devices in the ambient computing environments. The collected information may be reported to and maintained at one or more shared data storage areas, such as one or more data clearinghouses, for later retrieval by a service intended to consume the collected information.

Aspects of the disclosure are initially described in the context of wireless communications systems. Aspects of the disclosure are further illustrated by and described with reference to apparatus diagrams, system diagrams, and flowcharts that relate to an AIoT system architecture.

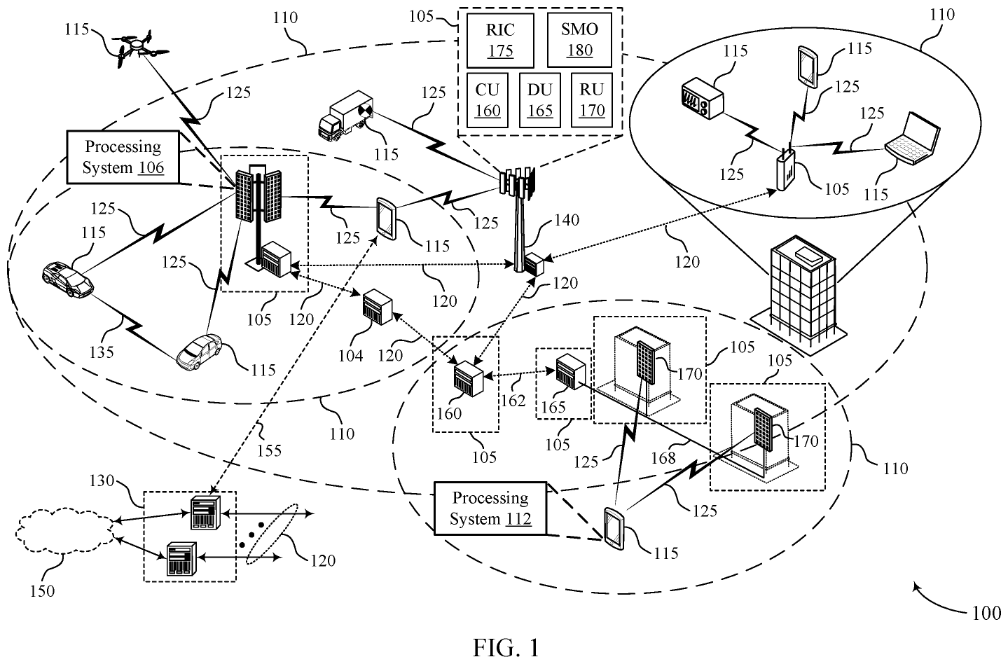

FIG. 1 shows an example of a wireless communications system 100 that supports an AIoT system architecture in accordance with one or more aspects of the present disclosure. The wireless communications system 100 may include one or more devices, such as one or more network devices (e.g., network entities 105), one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some aspects, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some aspects, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some aspects, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an IoT device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some aspects, a network entity 105 (e.g., a base station 140, an RU 170) may be movable and therefore provide communication coverage for a moving coverage area, such as the coverage area 110. In some aspects, coverage areas 110 (e.g., different coverage areas) associated with different technologies may overlap, but the coverage areas 110 (e.g., different coverage areas) may be supported by the same network entity (e.g., a network entity 105). In some other aspects, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1: M) system in which each UE 115 transmits to one or more of the UEs 115 in the group. In some aspects, a network entity 105 may facilitate the scheduling of resources for D2D communications. In some other aspects, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (cRedCap) device, an AIoT device, an EH-capable device, a network controller, an apparatus, a device, a computing system, an IAB node, a DU, a CU, an RU (which may also be referred to as an RRU), and/or another processing entity configured to perform any of the techniques described herein. For example, a network entity may be a UE. As another example, a network entity may be a base station. As used herein, “network entity” may refer to an entity that is configured to operate in a network, such as the network entity 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

Some wireless communications systems may include, operate in, or be integrated with an ambient computing environment. Such ambient computing environments may utilize connected IoT devices to harness information from the surrounding environment and provide intelligent services to users. In some cases, the IoT devices included in the ambient computing environment may include wireless devices, such as EH-capable devices (e.g., radio frequency identification (RFID) tags), non-EH-capable devices, battery powered devices, or other wireless devices. The wireless devices may interact with one or more other devices in the ambient computing environment to provide intelligent services to a user. For instance, the wireless devices may interact with a network device, such as a reader device, that may detect or read the wireless device. In some cases, the reader device may be the UE 115 or a network entity 105 (such as a base station 140). The reader device may communicate with one or more other network devices, such as one or more other network entities 105, to provide the intelligent services.

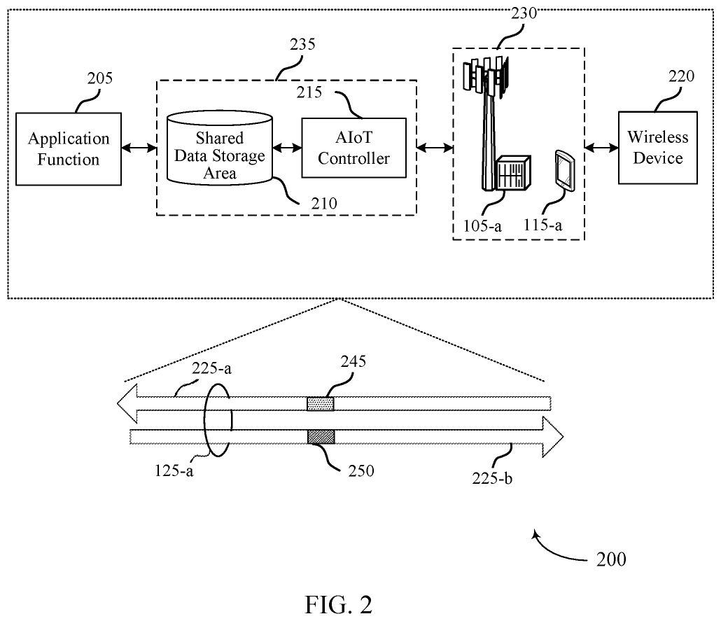

FIG. 2 shows an example of a wireless communications system 200 that supports an AIoT system architecture in accordance with one or more aspects of the present disclosure. The wireless communications system 200 may implement aspects of or may be implemented by aspects of the wireless communications system 100. For example, the wireless communications system 200 may include a UE 115-a or a network entity 105-a, which may be examples of a UE 115 and a network entity 105 described with respect to FIG. 1.

The wireless communications system 200 may include an application function 205, an AIoT controller 215 (implemented at a PLMN 235), a shared data storage area 210 (in some cases, also implemented at the PLMN 235), a reader device 230 (including a network entity 105-a or a UE 115-a), and a wireless device 220 (such as an EH-capable device, a non-EH-capable device, a battery powered device, or other wireless device). In some cases, the noted components of the wireless communications system 200 may be collectively referred to as “AIoT service components” of the wireless communications system 200.

The wireless device 220 may be a low-power, low-complexity IoT device, such as an RFID tag. Such devices may have minimal circuitry as compared with other user devices, such as the UE 115, and, as a result, may have minimal processing capabilities. Accordingly, in some cases, due to its low-power, low-complexity capabilities and processing functionalities, the wireless device 220 may not support certain standard features or functionality of other user devices, such as the UE 115. For instance, in some cases, the wireless device 220 may maintain minimal states. For example, session context management may not be supported, and the wireless device 220 may perform stateless operations. In some cases, the wireless device 220 may not support 3GPP defined protocol stacks due to overhead associated with implementing and operating such protocol stacks. In some cases, the wireless device 220 may not support subscriber identity module (SIM) functionality, such as SIM credentials, as the associated costs may exceed the costs of the wireless device 220 itself. In some cases, the wireless device 220 may have minimal cryptographic capabilities. Additionally, different wireless devices 220 may have different capabilities or support different functions. For instance, in some cases, the wireless device 220 may be a Type A device, a Type B device, a Type C device, or other type of wireless device. The Type A, Type B, and Type C devices may have different capabilities or support different functions.

The Type A wireless device 220 may be one that does not have the capability to store energy or to independently generate a signal. Instead, the Type A wireless device 220 may be an EH-capable device that utilizes back-scattering to transmit one or more signals based on an RF signal received from network-initiated communications only (NICO). For instance, the Type A wireless device 220 may harvest energy received from an RF signal (e.g., an energy signal) transmitted by a network entity, such as an RF signal transmitted by the reader device 230. The Type A wireless device 220 may utilize the harvested energy to perform back-scattering to transmit one or more signals back to the reader device 230 (or additionally or alternatively to a different reader device), such as by reflecting the received RF signal to transmit the one or more signals back to the reader device 230 (or additionally or alternatively to a different reader device). The capabilities of the Type A wireless device 220 may support short range and low data rate communications.

The Type B wireless device 220 may have the capability to store energy, but like the Type A wireless device, may not be capable of independently generating a signal. The Type B wireless device 220 may be an EH-capable device that utilizes back-scattering to transmit one or more signals back to the reader device 230 (or additionally or alternatively to a different reader device) based on harvesting energy from an RF signal received from the reader device 230, such as by reflecting the received RF signal to transmit the one or more signals back to the reader device 230 (or additionally or alternatively to a different reader device). In the case of the Type B wireless device 220, the stored energy may be used to amplify the reflected signals. The energy harvesting capabilities of the Type B wireless device 220 may support communications with a relatively longer range than those supported by the Type A wireless device 220.

In some cases, the Type A and Type B wireless devices 220 may operate as a special or new UE 115. As a result, in some cases, one or more core network functions may be adapted to support the new UE 115. For instance, NICO and mobility management functions may be partially hidden from other core network functions by regularly tracking or polling (e.g., tracking or polling at time intervals) by RAN or by an AMF. In other cases, one or more new core network functions may be enabled to support the new UE 115. For instance, in some cases, the new UE 115 may be completely or partially invisible to the core network, such as the core network 130, an a new mobility management function may be enabled.

The Type C wireless device 220, like the Type B wireless device 220 may be capable of storing energy. The Type C wireless device 220 may, unlike the Type A and Type B wireless devices 220, have an active RF component that may enable the device to independently generate signals. The Type C wireless device 220 may be an EH-capable device, a non-EH-capable device, a battery powered device, or other wireless device. In some cases, the Type C wireless device 220 may transmit uplink communications. In some cases, the uplink transmissions may operate as requests to the network. In other cases, the Type C wireless device 220 may, in addition to being capable of transmitting requests, may be capable of transmitting data. In cases where the Type C wireless device 220 is capable of transmitting requests, but not data, the Type C wireless device 220 may be similar to the Type A and Type B wireless devices 220 as it relates to core network functions, except that with the Type C wireless device 220 there may be a reduced need for network-based tracking or polling.

The reader device 230 may refer to a network device that may be utilized to detect or read the wireless device 220. For instance, the reader device 230 may be the network entity 105-a (such as the base station 140 of FIG. 1) or the UE 115-a. The reader device 230 may transmit one or more signals, such as one or more RF signals (e.g., energy signals) that may be received by the wireless device 220.

In some cases, the wireless device 220 may be an EH-capable device and may harvest (or in some cases, store) the energy from the received RF signal and use the energy to transmit one or more back-scattered signals back to the reader device 230. Additionally or alternatively, the wireless device 220 may harvest the energy from the received RF signal and use the energy to transmit one or more back-scattered signals to a different reader device. In some aspects, the back-scattered signal may be output using radio resources shared across a set of multiple MNOs (e.g., the shared spectrum). In other examples, the back-scattered signal may be output using dedicated radio resources associated with a specific MNO of a plurality of multiple MNOs (e.g., a dedicated spectrum). In other cases, the wireless device 220 may be a non-EH-capable device or a battery powered device and rather than transmitting a back-scattered signal, the wireless device 220 may transmit a non-back-scattered (such as an RF signal) to the reader device 230 (or to a different reader device) in response to the one or more signals from the reader device 230.

The signal from the wireless device 220 (e.g., the back-scattered or RF signal) may include information associated with the wireless device 220, such as identification information (e.g., a Tag Identifier (ID)). In some cases, the signal from the wireless device 220 may include additional information, such as enrichment data or information. The enrichment information may be information associated with or necessary to provide a service enabled at or associated with the wireless device 220 or at another connected device. For instance, the enrichment information may include information collected from a receiver disposed at the wireless device 220 (such as a global navigation satellite system (GNSS) location), information collected from a sensor disposed at the wireless device 220 (such as location information associated with the wireless device 220, environmental information associated with a surroundings of the wireless device 220 (e.g., temperature, humidity, barometric pressure, etc.), or other sensor-related information), device status information associated with the wireless device 220 (or other connected device), neighbor cell information (e.g., a neighbor cell ID), or other information that the wireless device 220 may be capable of collecting from the ambient computing environment.

In some cases, instead of, or in addition to, receiving the enrichment information from the wireless device 220, the reader device 230 may independently generate the enrichment information. For instance, the enrichment information generated by the reader device 230 may include information collected from a receiver disposed at the reader device 230 (such as a GNSS location), information collected from a sensor disposed at the reader device 230 (such as location information associated with the reader device 230, environmental information associated with a surroundings of the reader device 230 (e.g., temperature, humidity, barometric pressure, etc.), or other sensor-related information), device status information associated with the wireless device 220 or the reader device 230 (or other connected device), neighbor cell information (e.g., a neighbor cell ID), or other information that the reader device may be capable of collecting from the ambient computing environment. In some cases, the reader device 230 may further determine the location information associated with the wireless device 220 based on a location of the reader device 230 and a distance of the wireless device 220 from the reader device 230 as measured based on the signal received from the wireless device.

The reader device 230 may be configured (such as by the AIoT controller 215) to read or collect the identification information and generate the enrichment information. In some cases, the reader device 230 may be configured to read or collect the identification information and generate the enrichment information at predetermined times and/or at predetermined frequencies. Additionally or alternatively the reader device 230 may be configured to read or collect the identification information and generate the enrichment information when the signal from the wireless device 220 is detected. The reader device 230 may additionally be configured with the type of enrichment information to generate and report, the particular wireless devices 220 to report information from, or the like. In some cases, the configuration may be based on whether consent was provided from the reader device 230. In some cases, the reader device 230 may receive, from the AIoT controller 215, configuration information associated with the collection of information from the wireless device 220. The configuration information may provide an indication of the type of enrichment information to generate or collect, a time of collection, a frequency of collection, which wireless devices 220 to report information from (e.g., based on identification information), or the like. The AIoT controller 215 may determine the configuration information based on an AIoT service associated with particular wireless devices, based on capabilities of the reader devices 230, or based on MNO services enabled at or associated with the reader devices 230. The reader device 230 may, accordingly, collect and/or generate the enrichment information based on the configuration information.

The reader device 230 may report or transmit the collected or generated information (such as the identification information and enrichment information (either collected from the wireless device 220 or generated by the reader device 230)) to a network entity (such as a network entity 105) with which the reader device 230 is associated. For instance, the reader device 230 may be associated with a particular PLMN 235 (or mobile network operator (MNO)) and the reader device 230 may report the information to the AIoT controller 215 implemented at the particular PLMN 235 (or MNO). In some cases, more than one reader device 230 may detect or read the wireless device 220. In such cases, the multiple devices may report the respective collected and generated information to the AIoT controller 215 implemented at a particular PLMN 235 (or MNO) with which the reader device 230 is associated. As a result, in some cases, more than one AIoT controller 215 (such as, at different PLMNs 235 (or MNOs) may receive information associated with a single wireless device 220).

The AIoT controller 215 (or in some cases multiple AIoT controllers 215) may receive, from one or more reader devices 230, the identification information and/or the enrichment information associated with the wireless device 220. In some cases, the AIoT controller 215 may verify or process the received information and may generate service data or information that is associated with the wireless device 220. The AIoT controller 215 (e.g., each AIoT controller 215 when more than one receives information associated with the wireless device 220) may transmit the information to the shared data storage area 210.

The shared data storage area 210 may be a network entity (such as a network entity 105) that serves as a storage area that is shared across multiple PLMNs 235 (or multiple MNOs). For instance, the shared data storage area 210 may be a data clearinghouse where service data or information (such as the service data generated from the information collected or generated by multiple reader devices 230 (associated with multiple PLMNs 235)) may be stored for later access by an application function 205 that supports a service associated with the service data. In some cases, the shared data storage area 210 may be implemented at one of the PLMNs 235, such as a designated or contracted PLMN. In other cases, the shared data storage area 210 may be implemented as separate and distinct network entity (such as a network entity 105) apart from any of the PLMNs 235.

The application function 205 may support the service enabled at or associated with the wireless device 220. Accordingly, to provision the service, the application function 205 may request, from the shared data storage area 210 (or in some cases from the AIoT controller 215), the stored service data associated with the wireless device 220. The application function 205, in some cases, may coordinate with an AIoT provisioning service that may provision the wireless device 220 to the application function 205 (e.g., an AIoT application service) and manage credential between the application function and the wireless device 220. In some cases, a given AIoT provisioning service may be associated with multiple different application functions.

One or more of the AIoT service components may communicate using a communication link 125-a (which may be an example of the communication link 125 of FIG. 1). The communication link 125-a may include a first channel 225-a and a second channel 225-b. The communication link 125-a may be an example of an application protocol, a transport layer security (TLS), an NR link, or an LTE link (among other examples) between the AIoT service components. The communication link 125-a may include a bi-directional link that enables uplink and downlink communications, for example, via the channels 225-a and 225-b. For instance, the first channel 225-a may be used for transmitting data, such as uplink messages 245, from a first AIoT service component to a second AIoT service component; and the second channel 225-b may be used for transmitting data, such as downlink messages 250, from the second AIoT service component to the first AIoT service component.

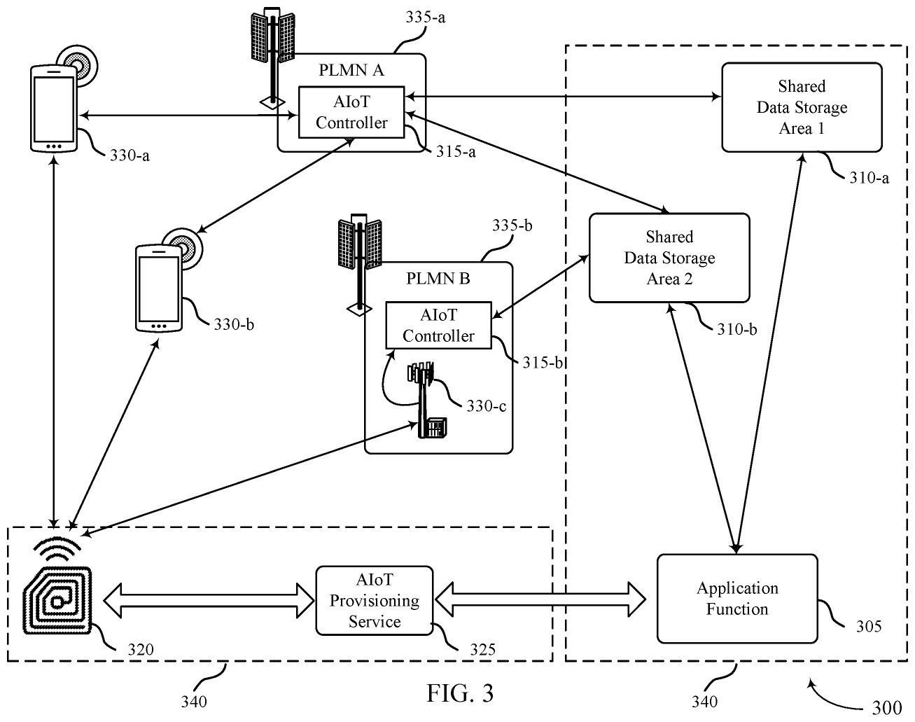

FIG. 3 shows an example of a wireless communications system 300 that supports an AIoT system architecture in accordance with one or more aspects of the present disclosure. The wireless communications system 300 may implement aspects of or may be implanted by aspects of the wireless communications systems 100 or 200, described with reference to FIGS. 1 and 2, respectively.

The wireless communications system 300 may include an application function 305, one or more shared data storage areas 310 (e.g., shared data storage area 1 310-a and shared data storage area 2 310-b), a plurality of AIoT controllers 315 (e.g., a first AIoT controller 315-a and a second AIoT controller 315-b) implemented at a plurality of PLMNs 335 (e.g., PLMN A 335-a and PLMN B 335-b) across a plurality of different MNOs (not shown), a plurality of reader devices 330 (e.g., a first reader device 330-a, a second reader device 330-b, and a third reader device 330-c) associated with the plurality of PLMNs 335 (e.g., the first reader device 330-a and the second reader device 330-b being associated with the PLMN A 335-a and the third reader device 330-c being associated with the PLMN B 335-b), a wireless device, such as an EH-capable device 320, and an AIoT provisioning service 325. Although aspects of the wireless communications system 300 are illustrated and described with reference to a wireless device that is EH-capable (e.g., the EH-capable device 320), the described aspects are not limited to EH-capable devices and may additionally or alternatively relate to other types of wireless devices in an ambient computing environment, such as non-EH-capable devices, battery-powered devices, other wireless devices, or a combination thereof.

In the example wireless communications system 300, the plurality of PLMNs 335 across the plurality of different MNOs may opt to participate in a shared operator service offering 340 (facilitated by the application function 305, the one or more shared data storage areas 310, the AIoT provisioning service 325, and the EH-capable device 320). The shared operator service offering 340 may allow the plurality of PLMNs 335 across the plurality of different MNOs to collaborate to enhance coverage for providing intelligent services in ambient computing environments. The shared operator service offering 340 may allow participating PLMNs 335 to leverage network entities, such as the plurality of reader devices 330, that are associated with the plurality of PLMNs 335, to collect information and data from IoT devices, such as EH-capable devices 320, in ambient computing environments. For instance, the EH-capable device 320 may be associated with a first PLMN, such as PLMN A 335-a, and to provide a service (e.g., a location tracking service) enabled at or associated with the EH-capable device 320, the PLMN A 335-a may require the collection of information associated with the EH-capable device 320. The shared operator service offering 340 may enable network devices other than (e.g., in addition to) those associated with the PLMN A 335-a (for example, reader device 330-c that is associated with the PLMN B 335-b) to collect information associated with the EH-capable device 320 on behalf of the PLMN A 335-a. The collected information may be reported to and maintained at one or more shared data storage areas 310, such as one or more data clearinghouses, for later retrieval by an application function 305 associated with the PLMN 335 to whom the collected information belongs, such as PLMN A 335-a.

In some cases, the application function 305 may coordinate with the AIoT provisioning service 325 to provide the service (e.g., the location tracking service) enabled at or associated with the EH-capable device 320. For instance, the application function 305 may provide the service and the AIoT provisioning service 325 may provision the EH-capable device 320 to the application function 305. The application function 305 may register the EH-capable device 320 among a list of EH-capable devices 320 provisioned to the application function 305. In some cases, the EH-capable device 320 and its associated data may be protected or encrypted to avoid unauthorized tracking or surveillance of the EH-capable devices 320 and their associated information. In this way, only an owner (such as the application function 305) of the EH-capable device 320 may be authorized to access the data. Accordingly, the AIoT provisioning service 325 may manage end-to-end security between the EH-capable device 320 and the application function 305 by provisioning symmetric or protection keys (e.g., private keys and/or public keys) to both the EH-capable device 320 and the application function 305 for enabling encoding (e.g., encrypting) and decoding (e.g., decrypting) data (e.g., identification information and enrichment information), and enabling the application function 305 to access data associated with the EH-capable device 320.

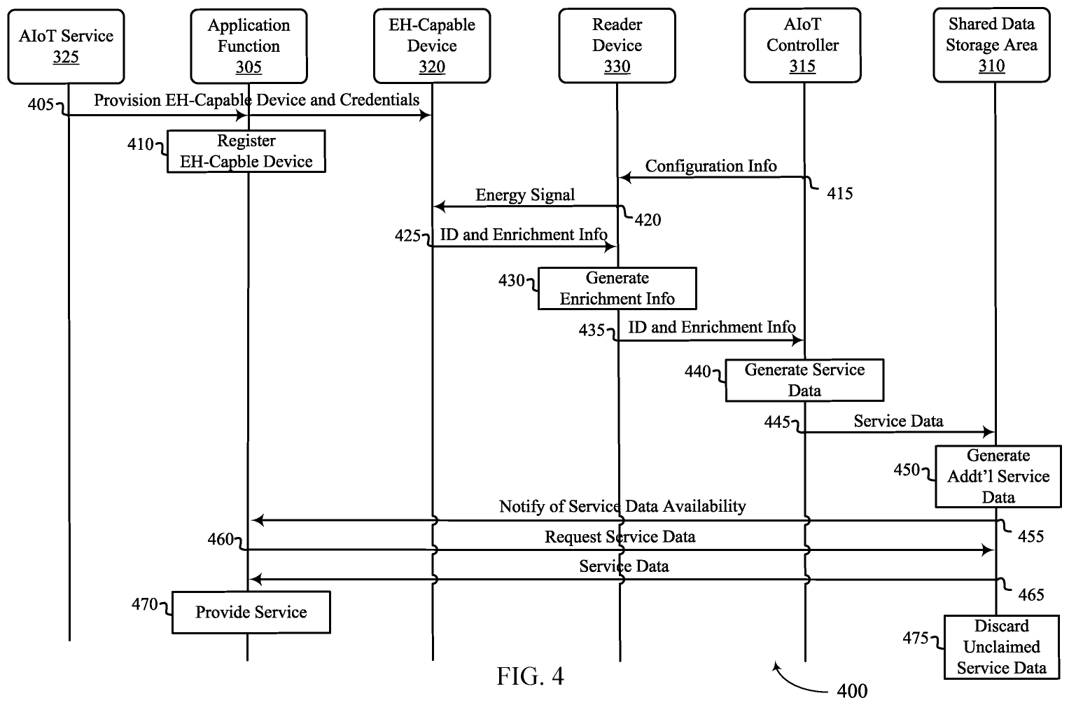

FIG. 4 shows an example signal flow 400 that supports an AIoT system architecture in accordance with one or more aspects of the present disclosure. In some aspects, the signal flow 400 may implement or be implemented by aspects of the wireless communications systems 100, 200, and 300 as described with reference to FIGS. 1, 2, and 3 respectively. For example, the signal flow 400 may illustrate the flow of signals between the AIoT provisioning service 325, the application function 305, the EH-capable device 320, one or more reader devices 330, one or more AIoT controllers 315, and the one or more shared data storage areas 310, as described with reference to FIG. 3. In some cases the one or more shared data storage areas 310 may be maintained at a particular PLMN 335 and a corresponding AIoT controller of that PLMN 335 may perform one or more of the functions described as being provided by the one or more shared data storage areas 310. Although aspects of the signal flow 400 are illustrated and described with reference to the EH-capable device 320, the described aspects are not limited to EH-capable devices and may additionally or alternatively relate to other types of wireless devices in an ambient computing environment, such as non-EH-capable devices, battery-powered devices, other wireless devices, or a combination thereof.

At step 405, the AIoT provisioning service 325 may provision the EH-capable device 320 to a particular application function 305 that may utilize the EH-capable device 320 to provide an intelligent service in an ambient computing environment. In some cases, the provisioning may include providing credentials (such as device identity, shared keys, or both) to both the EH-capable device 320 and the application function 305 for enabling encoding (e.g., encrypting) and decoding (e.g., decrypting) data (e.g., identification information and enrichment information), and enabling the application function 305 to access data associated with the EH-capable device 320.

At step 410, the provisioning by the AIoT provisioning service 325 may trigger the application function 305 to register the EH-capable device 320 with the application function 305. For instance, identification information of the EH-capable device 320 may be maintained in a list of EH-capable devices 320 provisioned to the application function 305.

At step 415, the AIoT controller 315 may transmit, to one or more reader device 330, configuration information associated with enrichment information to be generated or collected by each of the one or more reader devices 330. The configuration information may include an indication of the type of enrichment information to generate or collect, a time of collection, a frequency of collection, which EH-capable devices 320 to report information from (e.g., based on identification information), or the like. The configuration information may be based on an AIoT service associated with particular EH-capable devices 320, based on capabilities of the one or more reader devices 330, or based on MNO services enabled at or associated with the one or more reader devices 330.

At step 420, the one or more reader devices 330 may generate and transmit an energy signal, such as an RF signal. In some cases, the one or more reader devices 330 may be selected or triggered to transmit the energy signal based on a last known or a potential location of the EH-capable device 320. Alternatively or additionally, the one or more reader devices 330 may be selected based on the configuration information from the AIoT controller 315 to transmit the energy signal.

At step 425, when the one or more reader devices 330 are in proximity to the EH-capable device 320, the EH-capable device 320 may detect the energy signal. Detecting the energy signal may enable a service at the EH-capable device 320 and may trigger or activate the EH-capable device 320 to output a back-scattered signal (or other signal) back to the one or more reader devices 330 (or to one or more different reader devices). For instance, to output the back-scattered signal, the EH-capable device 320 may harvest energy received from the RF signal and utilize the energy to generate the back-scattered signal. In some cases, the process of the EH-capable device 320 receiving the signal from the one or more reader devices 330 and outputting the back-scattered signal back to the one or more reader devices 330 (or to one or more different reader devices) may be referred to as the one or more reader devices 330 reading the EH-capable device 320. Although the EH-capable device 320 may be associated with a particular PLMN 335, such as the PLMN A 335-a (or a particular MNO), the EH-capable device 320 may be agnostic in terms of the reader devices 330 that are capable of reading the EH-capable device 320. Accordingly, the EH-capable device 320 may be read by a reader device 330 associated with any PLMN 335 (or any MNO) participating in the shared operator service offering 340.

The signal (e.g., the back-scattered signal or other signal) output by the EH-capable device 320 may include an indication of identification information of the EH-capable device 320. For instance, the identification information may be a Tag ID associated with the EH-capable device 320. In some case, when the EH-capable device 320 has the capability, the signal output by the EH-capable device 320 may additionally include enrichment information associated with the service enabled at or associated with the EH-capable device 320. The enrichment information may be information associated with an environment in which the EH-capable device 320 operates. For instance, the enrichment information may include sensor information (such as location information (e.g., a global navigation satellite system (GNSS) location) associated with the EH-capable device 320, environmental information (e.g., a temperature, humidity, barometric pressure, etc.), or other sensor-related information) associated with a surroundings of the EH-capable device 320, device status information associated with the EH-capable device 320 (or other connected device), neighbor cell information (e.g., a neighbor cell ID), or other information that EH-capable device 320 may be capable of collecting from the ambient computing environment. In some cases, the information output via the signal from the EH-capable device 320, such as the identification information and/or the enrichment information, may be protected (such as encrypted or encoded) using the credentials provisioned by the AIoT provisioning service 325.

At step 430, the one or more reader devices 330 may receive the information from EH-capable device 320 and independently generate enrichment information. For instance, the one or more reader devices 330 may receive the identification information and/or the enrichment information from the EH-capable device 320. In some cases, instead of, or in addition to, receiving the enrichment information from the EH-capable device 320, the reader devices 330 may independently generate enrichment information. The enrichment information may be generated based on the configuration information received from the AIoT controller 315. The enrichment information may be information associated with an environment in which the EH-capable device 320 or the one or more reader devices 330 operates. The one or more reader devices 330 may determine the type of enrichment information to generate based on the configuration information received from the AIoT controller 315. The configuration information may be based on an AIoT service associated with the EH-capable device 320, based on capabilities of the one or more reader devices 330, or based on MNO services enabled at or associated with the one or more reader devices 330.

At step 435, after receiving the information from the EH-capable device 320 and/or independently generating information associated with the EH-capable device 320, the one or more reader devices 330 may report or transmit the collected and/or generated information to the AIoT controller at the PLMN 335 with which the reader device 330 is associated. For instance, the reader devices 330-a and 330-b may be associated with the PLMN A 335-a and may report any collected and/or generated information associated with the EH-capable device 320 to the AIoT controller 315-a at the PLMN A 335-a. The reader device 330-c may be associated with the PLMN B 335-b and may report any collected and/or generated information associated with the EH-capable device 320 to the AIoT controller 315-b at the PLMN B 335-b.

At step 440, the one or more AIoT controllers 315 may receive the information from the one or more reader devices 330 and may process the received information to generate service data. In some cases, such as when information associated with a single EH-capable device 320 is received from multiple reader devices 330 at one of the AIoT controllers 315, processing the received information may involve aggregating the received information. For example, when the enrichment information collected for the EH-capable device 320 is a location information, if the AIoT controller 315 receives location information from multiple reader devices 330, the AIoT controller 315 may perform triangulation or technique to estimate an accurate location associated with the EH-capable device 320. As another example, when the enrichment information collected for the EH-capable device 320 is temperature information, if the AIoT controller 315 receives temperature information from multiple reader devices 330, the AIoT controller 315 may aggregate the information such as by calculating an average temperature from the collected information. In some cases, however, the AIoT controller 315 may not process the information, and may instead simply report the received information to one of the one or more shared data storage areas 310. For instance, in some cases, such as when the EH-capable device 320 generates enrichment information on its own, the information may be protected such that the AIoT controller 315 may not be authorized to access a decoded version of the information.

At step 445, each of the one or more AIoT controllers 315 may report the processed (e.g., aggregated) service data (or in some cases the raw received information when the AIoT controllers 315 do not process the received information) associated with the EH-capable device 320 to one of the one or more shared data storage areas 310. In some cases, the one or more AIoT controllers 315 may determine or identify a shared data storage area 310 to report the service data to based on a type of data or a type of service. For instance, for certain services, associated service data may be reported to the shared data storage area 1 310-a, and for other services, such as those supporting highly sensitive or critical data, the service data may be reported to the shared data storage area 2 310-b. In some cases, the AIoT controllers 315 may determine or identify the shared data storage area 310 to report the service data to based on routing information associated with identification information (e.g., the Tag ID) associated with the service data, based on a location indicated by the service data, or based on the shared data storage area 310 being associated with a contracted PLMN or a PLMN with a service level agreement.

At step 450, the one or more shared data storage areas 310 may receive the service data associated with the EH-capable device 320 from one or more of the AIoT controllers 315. When a given shared data storage area 310 receives service data for a single EH-capable device 320 from multiple AIoT controllers 315, the shared data storage area 310 may process the received service data to generate additional service data. For instance, the shared data storage area 310 may process the information in the manner with respect to step 440. In some cases, the received service data may not be processed at the shared data storage area 310 (such as when the shared data storage area 310 does not have authorization to access the decoded service data).

At step 455, upon receipt of the service data associated with the EH-capable device 320, the shared data storage area 310 may notify an application function 305 that may be associated with the EH-capable device 320 and/or the corresponding service data. For instance, the shared data storage area 310 may notify the application function 305 of an availability of the service data associated with the EH-capable device 320.

At step 460, based on the notification from the shared data storage area 310, the application function 305 may transmit a request to the appropriate shared data storage area 310 for the service data associated with the EH-capable device 320. For instance, the request may include an indication of the identification information associated with the EH-capable device 320. In some cases, the application function 305 may transmit, to one or more of the shared data storage areas 310, a request including identification information (e.g., Tag IDs) associated with one or more EH-capable devices 320 to poll the one or more shared data storage areas 310 for the availability of service data associated with the requested EH-capable devices 320.

At step 465, one or more of the data storage areas 310 may receive, from the application function 305, the request comprising the identification information for one or more EH-capable device 320 and may transmit the corresponding service data to the application function. In some cases, the data storage area 310, when transmitting the service data, may additionally transmit a charging record to the application function 305. The charging record may indicate a cost to the application function 305 (or corresponding PLMN or MNO) for a service of maintaining and providing the service data to the application function 305.

At step 470, the application function 305 may receive the service data and may decode or decrypt the service data (such is using the credentials provisioned by the AIoT provisioning service 325). The application function 305 may utilize the service data to provide the intelligent service in the ambient computing environment. For example, the application function 305 may utilize location information received in the service data to provide a location tracking service (e.g., output a location of the EH-capable device 330).

At step 475, to maintain an integrity of the one or more shared data storage areas 310, each shared data storage area 310 may be configured by an associated MNO to periodically (or in some cases, aperiodically or randomly) tag service data stored in the shared data storage area 310 that has been unclaimed by an application function 305 for a period of time (such as a period of time since the service data was reported to the shared data storage area 310). Such service data may be tagged as unclaimed or invalid and may be discarded or removed from the shared data storage area 310 after a period of time. In some cases, the AIoT provisioning service 325 may configure the shared data storage area 310 for such periodic tagging and removal of unclaimed service data. For instance, the AIoT provisioning service may provide the periodic tagging and removal of the unclaimed service data as a common service to multiple MNOs. By removing unclaimed service data, the one or more shared data storage areas 310 may indirectly verify an authenticity of data, such as the identification information (which may be susceptible to malicious actors injecting illegitimate identification information), reported to the one or more shared data storage areas 310.

In accordance with the above-described process, the one or more PLMNs 335 (across a plurality of MNOs) may collaborate to extend coverage to provide intelligent services in an ambient computing environment.

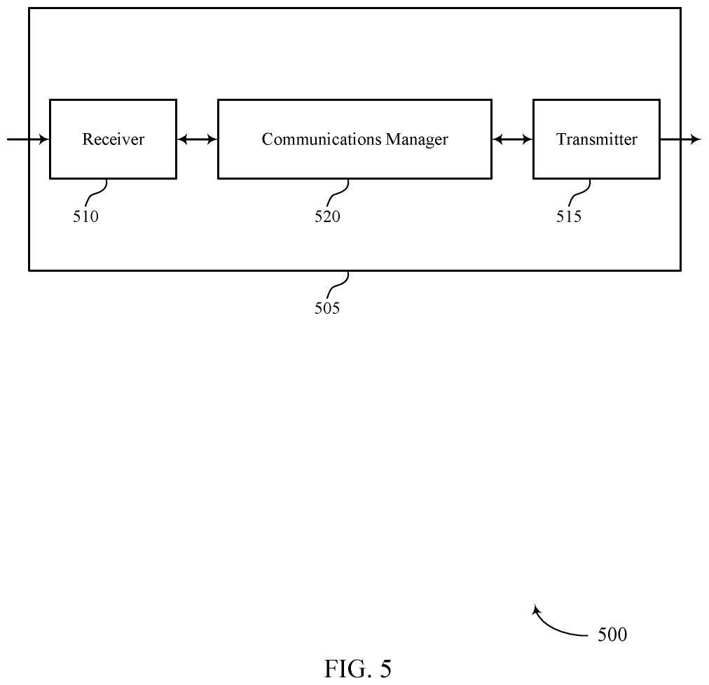

FIG. 5 shows a block diagram 500 of a device 505 that supports AIoT system architecture in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some aspects, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some aspects, the transmitter 515 and the receiver 510 may be co-located in a transceiver, which may include or be coupled with a modem.

The communications manager 520, the receiver 510, the transmitter 515, or various combinations or components thereof may be examples of means for performing various aspects of AIoT system architecture as described herein. For example, the communications manager 520, the receiver 510, the transmitter 515, or various combinations or components thereof may be capable of performing one or more of the functions described herein.

In some aspects, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving, from a network configuration information indicating a type of enrichment information to collect. The communications manager 520 is capable of, configured to, or operable to support a means for receiving a back-scattered signal from an EH-capable device, where the back-scattered signal includes identification information associated with the EH-capable device. The communications manager 520 is capable of, configured to, or operable to support a means for obtaining, based at least in part on the configuration information, enrichment information associated with the EH-capable device, where the enrichment information is separate from the identification information. The communications manager 520 is capable of, configured to, or operable to support a means for causing transmission of the identification information and the enrichment information to the second network entity.

Additionally, or alternatively, the communications manager 520 may support wireless communications in accordance with examples as disclosed herein. For example, the communications manager 520 is capable of, configured to, or operable to support a means for causing transmission of configuration information to one or more second network entities, where the configuration information indicates a type of enrichment information to collect. The communications manager 520 is capable of, configured to, or operable to support a means for receiving, from the one or more second network entities, one or more signals including identification information associated with an EH-capable device and enrichment information associated with a service. The communications manager 520 is capable of, configured to, or operable to support a means for generating, based on aggregation of the enrichment information received from the one or more second network entities, service information associated with the service. The communications manager 520 is capable of, configured to, or operable to support a means for sending, to a data storage area, the identification information associated with the EH-capable device and the service information associated with the service.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

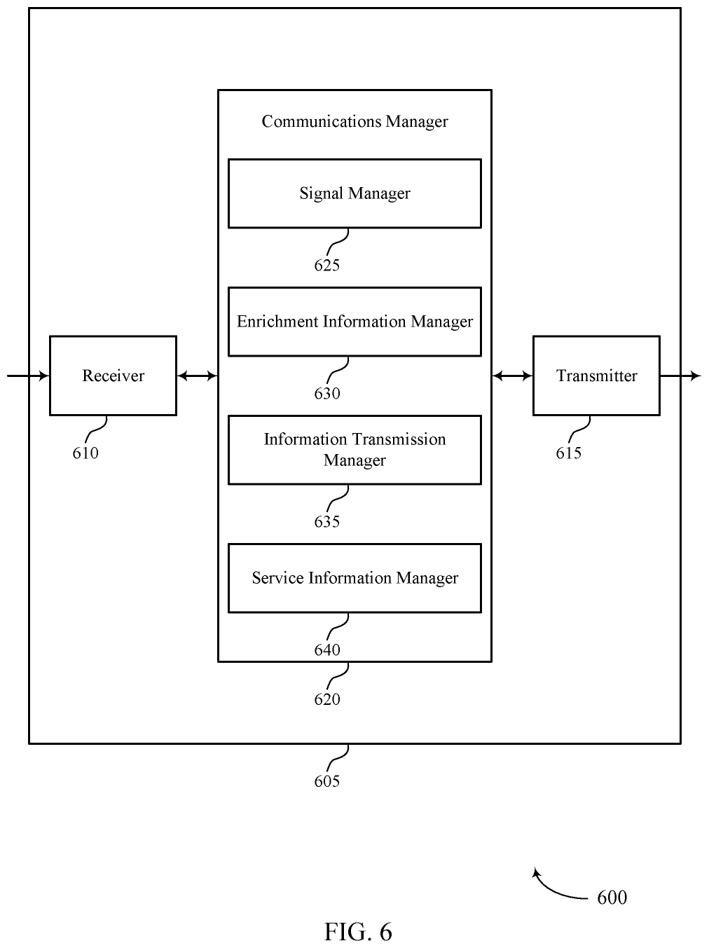

FIG. 6 shows a block diagram 600 of a device 605 that supports AIoT system architecture in accordance with one or more aspects of the present disclosure. The device 605 may be an example of aspects of a device 505 or a network entity 105 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some aspects, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some aspects, the transmitter 615 and the receiver 610 may be co-located in a transceiver, which may include or be coupled with a modem.

The device 605, or various components thereof, may be an example of means for performing various aspects of AIoT system architecture as described herein. For example, the communications manager 620 may include a signal manager 625, an enrichment information manager 630, an information transmission manager 635, a service information manager 640, or any combination thereof. The communications manager 620 may be an example of aspects of a communications manager 520 as described herein. In some aspects, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The enrichment information manager 630 is capable of, configured to, or operable to support a means for receiving, from a second network entity, configuration information indicating a type of enrichment information to collect. The signal manager 625 is capable of, configured to, or operable to support a means for receiving a back-scattered signal from an EH-capable device, where the back-scattered signal includes identification information associated with the EH-capable device. The enrichment information manager 630 is capable of, configured to, or operable to support a means for obtaining, based at least in part on the configuration information, enrichment information associated with the EH-capable device, where the enrichment information is separate from the identification information. The information transmission manager 635 is capable of, configured to, or operable to support a means for causing transmission of the identification information and the enrichment information to the second network entity.

Additionally, or alternatively, the communications manager 620 may support wireless communications in accordance with examples as disclosed herein. The enrichment information manager 630 is capable of, configured to, or operable to support a means for causing transmission of configuration information to one or more second network entities, wherein the configuration information indicates a type of enrichment information to collect. The signal manager 625 is capable of, configured to, or operable to support a means for receiving, from the one or more second network entities, one or more signals including identification information associated with an EH-capable device and enrichment information associated with a service. The service information manager 640 is capable of, configured to, or operable to support a means for generating, based on aggregation of the enrichment information received from the one or more second network entities, service information associated with the service. The information transmission manager 635 is capable of, configured to, or operable to support a means for sending, to a data storage area, the identification information associated with the EH-capable device and the service information associated with the service.

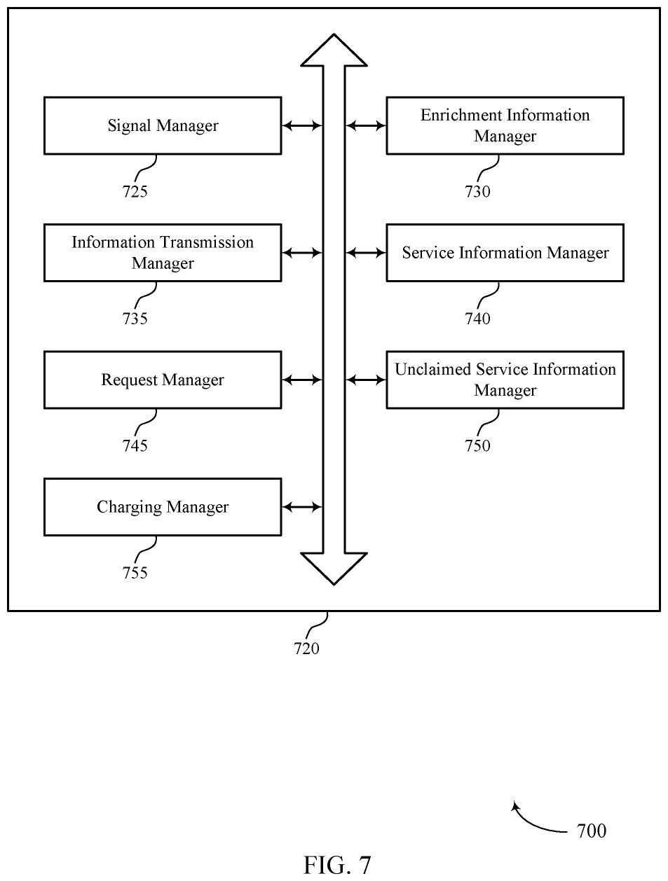

FIG. 7 shows a block diagram 700 of a communications manager 720 that supports AIoT system architecture in accordance with one or more aspects of the present disclosure. The communications manager 720 may be an example of aspects of a communications manager 520, a communications manager 620, or both, as described herein. The communications manager 720, or various components thereof, may be an example of means for performing various aspects of AIoT system architecture as described herein. For example, the communications manager 720 may include a signal manager 725, an enrichment information manager 730, an information transmission manager 735, a service information manager 740, a request manager 745, an unclaimed service information manager 750, a charging manager 755, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The enrichment information manager 730 is capable of, configured to, or operable to support a means for receiving, from a second network entity, configuration information indicating a type of enrichment information to collect. The signal manager 725 is capable of, configured to, or operable to support a means for receiving a back-scattered signal from an EH-capable device, where the back-scattered signal includes identification information associated with the EH-capable device. The enrichment information manager 730 is capable of, configured to, or operable to support a means for obtaining, based at least in part on the configuration information, enrichment information associated with the EH-capable device, where the enrichment information is separate from the identification information. The information transmission manager 735 is capable of, configured to, or operable to support a means for causing transmission of the identification information and the enrichment information to the second network entity.

In some aspects, obtaining the enrichment information includes receiving the enrichment information via the back-scattered signal.

In some aspects, obtaining the enrichment information includes generating, based on configuration by the second network entity, the enrichment information.

In some aspects, generating the enrichment information includes collecting, using a sensor at the EH-capable device, the enrichment information. In some aspects, the enrichment information includes sensor information.

In some aspects, the sensor information includes location information or environmental information.

In some aspects, the enrichment information includes device status information or neighbor cell information.

In some aspects, the signal manager 725 is capable of, configured to, or operable to support a means for causing transmission of a first signal to the EH-capable device, where the first signal includes an energy signal for energy harvesting, where the back-scattered signal is received in response to the first signal.

In some aspects, the first network entity includes a base station, one or more components of a base station, or a UE.

Additionally, or alternatively, the communications manager 720 may support wireless communications in accordance with examples as disclosed herein. In some aspects, the enrichment information manager 730 is capable of, configured to, or operable to support a means for causing transmission of configuration information to one or more second network entities, wherein the configuration information indicates a type of enrichment information to collect. The signal manager 725 is capable of, configured to, or operable to support a means for receiving, from the one or more second network entities, one or more signals including identification information associated with an EH-capable device and enrichment information associated with a service. The service information manager 740 is capable of, configured to, or operable to support a means for generating, based on aggregation of the enrichment information received from the one or more second network entities, service information associated with the service. In some aspects, the information transmission manager 735 is capable of, configured to, or operable to support a means for sending, to a data storage area, the identification information associated with the EH-capable device and the service information associated with the service.

In some aspects, the data storage area includes a data clearinghouse shared by a set of multiple PLMNs.

In some aspects, the first network entity is associated with a mobile network operator or a PLMN.

In some aspects, the request manager 745 is capable of, configured to, or operable to support a means for receiving, from an application function, a request for information associated with a first EH-capable device, where the request includes identification information associated with the first EH-capable device. In some aspects, the service information manager 740 is capable of, configured to, or operable to support a means for sending, to the application function and based on the identification information associated with the first EH-capable device, service information associated with the first EH-capable device.

In some aspects, the charging manager 755 is capable of, configured to, or operable to support a means for sending, to the application function, a charging record for the service information associated with the first EH-capable device.

In some aspects, the unclaimed service information manager 750 is capable of, configured to, or operable to support a means for tagging service information as unclaimed based on a determination that no request for the service information has been received within a threshold period of time from receipt of the service information from the one or more second network entities.

In some aspects, the unclaimed service information manager 750 is capable of, configured to, or operable to support a means for causing unclaimed service information and corresponding identification information to be removed from the data storage area after the threshold period of time.

In some aspects, to support sending the identification information and the service information to the data storage area, the information transmission manager 735 is capable of, configured to, or operable to support a means for identifying the data storage area from among a set of multiple data storage areas based on a type of the service information, routing information associated with the identification information, a location indicated by the service information, a contracted PLMN associated with the data storage area, or a service level agreement associated with a PLMN associated with the data storage area. In some aspects, to support sending the identification information and the service information to the data storage area, the information transmission manager 735 is capable of, configured to, or operable to support a means for sending the identification information and the service information to the identified data storage area.

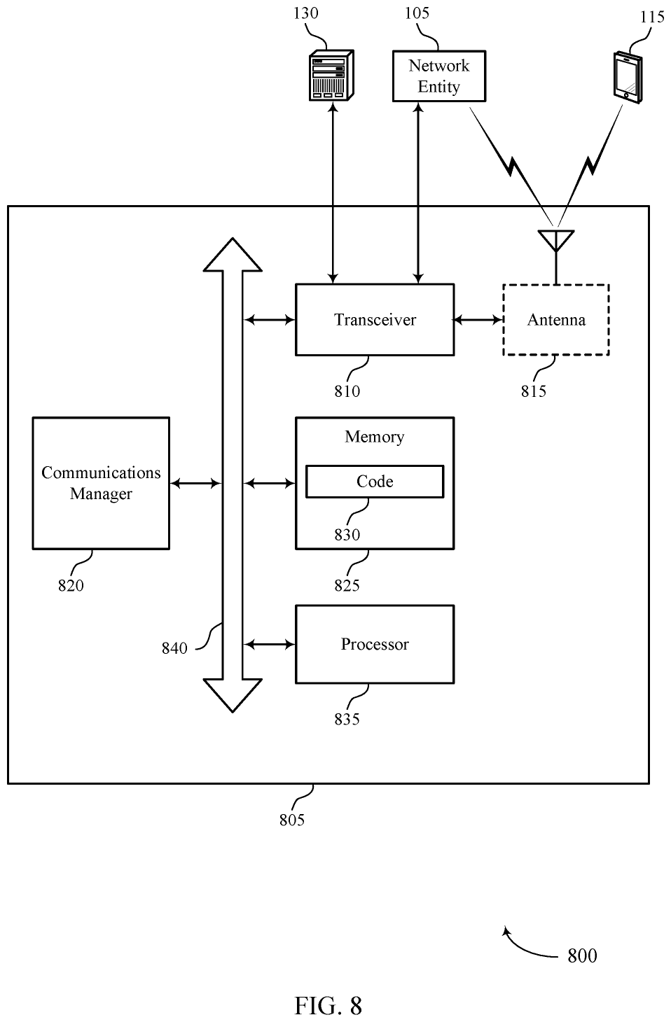

FIG. 8 shows a diagram of a system 800 including a device 805 that supports AIoT system architecture in accordance with one or more aspects of the present disclosure. The device 805 may be an example of or include components of a device 505, a device 605, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some aspects, the transceiver 810 may include a wired transceiver and may communicate bi-directionally with another wired transceiver. Additionally, or alternatively, in some aspects, the transceiver 810 may include a wireless transceiver and may communicate bi-directionally with another wireless transceiver. In some aspects, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some aspects, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some aspects, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting AIoT system architecture). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825). In some aspects, the at least one processor 835 may include multiple processors and the at least one memory 825 may include multiple memories. One or more of the multiple processors may be coupled with one or more of the multiple memories, which may, individually or collectively, be configured to perform various functions herein. In some aspects, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some aspects, a bus 840 may support communications of (e.g., within) a protocol layer of a protocol stack. In some aspects, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some aspects, the communications manager 820 may manage aspects of communications with a core network 130 (e.g., via one or more wired or wireless backhaul links). For example, the communications manager 820 may manage the transfer of data communications for client devices, such as one or more UEs 115. In some aspects, the communications manager 820 may manage communications with one or more other network entities 105, and may include a controller or scheduler for controlling communications with UEs 115 (e.g., in cooperation with the one or more other network devices). In some aspects, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for receiving, from a second network entity, configuration information indicating a type of enrichment information to collect. The communications manager 820 is capable of, configured to, or operable to support a means for receiving a back-scattered signal from an energy harvesting (EH)-capable device, where the back-scattered signal includes identification information associated with the EH-capable device. The communications manager 820 is capable of, configured to, or operable to support a means for obtaining enrichment information associated with the EH-capable device, where the enrichment information is separate from the identification information. The communications manager 820 is capable of, configured to, or operable to support a means for causing transmission of the identification information and the enrichment information to the second network entity.

Additionally, or alternatively, the communications manager 820 may support wireless communications in accordance with examples as disclosed herein. For example, the communications manager 820 is capable of, configured to, or operable to support a means for causing transmission of configuration information to one or more second network entities, wherein the configuration information indicates a type of enrichment information to collect. The communications manager 820 is capable of, configured to, or operable to support a means for receiving, from the one or more second network entities, one or more signals including identification information associated with an energy harvesting (EH)-capable device and enrichment information associated with a service. The communications manager 820 is capable of, configured to, or operable to support a means for generating, based on aggregation of the enrichment information received from the one or more second network entities, service information associated with the service. The communications manager 820 is capable of, configured to, or operable to support a means for sending, to a data storage area, the identification information associated with the EH-capable device and the service information associated with the service.

By including or configuring the communications manager 820 in accordance with examples as described herein, the device 805 may support techniques for improved communication reliability, more efficient utilization of communication resources, improved coordination between devices, and improved utilization of processing capability.

In some aspects, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some aspects, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of AIoT system architecture as described herein, or the at least one processor 835 and the at least one memory 825 may be otherwise configured to, individually or collectively, perform or support such operations.

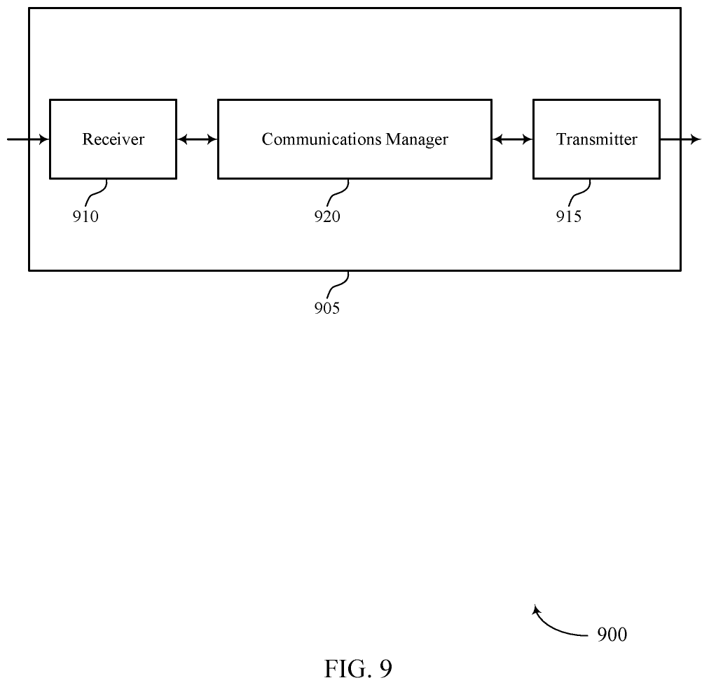

FIG. 9 shows a block diagram 900 of a device 905 that supports AIoT system architecture in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to AIoT system architecture). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to AIoT system architecture). In some aspects, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of AIoT system architecture as described herein. For example, the communications manager 920, the receiver 910, the transmitter 915, or various combinations or components thereof may be capable of performing one or more of the functions described herein.

In some aspects, the communications manager 920, the receiver 910, the transmitter 915, or various combinations or components thereof may be implemented in hardware (e.g., in communications management circuitry). The hardware may include at least one of a processor, a digital signal processor (DSP), CPU, an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for enabling, based on detection of a first signal from a network entity, a service associated with the EH-capable device. The communications manager 920 is capable of, configured to, or operable to support a means for obtaining enrichment information associated with the service. The communications manager 920 is capable of, configured to, or operable to support a means for outputting a back-scattered signal including identification information associated with the EH-capable device and the enrichment information.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

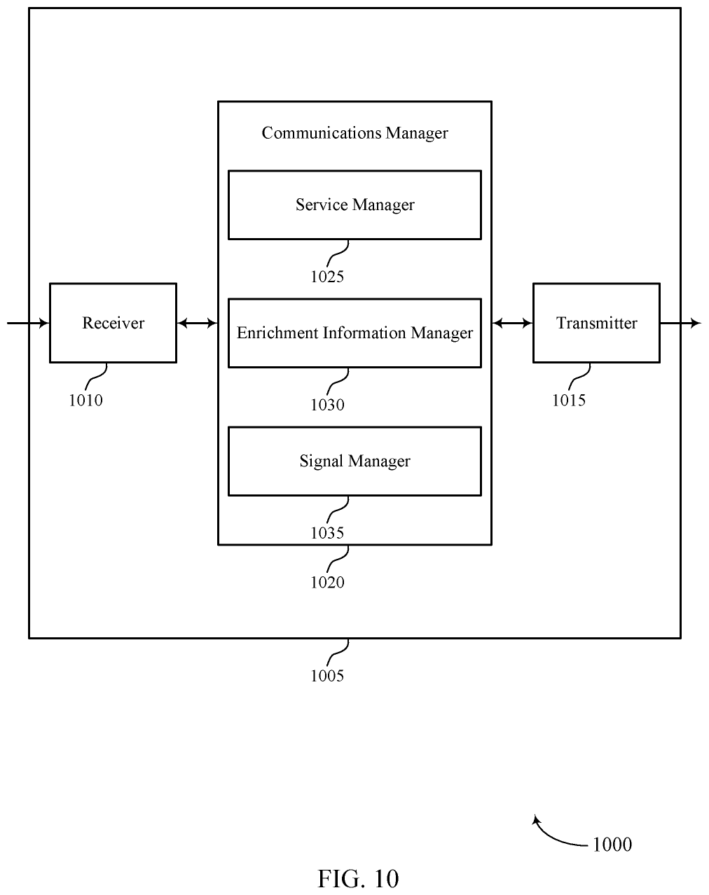

FIG. 10 shows a block diagram 1000 of a device 1005 that supports AIoT system architecture in accordance with one or more aspects of the present disclosure.

The device 1005 may be an example of aspects of a device 905 or a UE 115 as described herein. The device 1005 may include a receiver 1010, a transmitter 1015, and a communications manager 1020. The device 1005, or one of more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to AIoT system architecture). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to AIoT system architecture). In some aspects, the transmitter 1015 may be co-located with a receiver 1010 in a transceiver module. The transmitter 1015 may utilize a single antenna or a set of multiple antennas.

The device 1005, or various components thereof, may be an example of means for performing various aspects of AIoT system architecture as described herein. For example, the communications manager 1020 may include a service manager 1025, an enrichment information manager 1030, a signal manager 1035, or any combination thereof. The communications manager 1020 may be an example of aspects of a communications manager 920 as described herein. In some aspects, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The service manager 1025 is capable of, configured to, or operable to support a means for enabling, based on detection of a first signal from a network entity, a service associated with the EH-capable device. The enrichment information manager 1030 is capable of, configured to, or operable to support a means for obtaining enrichment information associated with the service. The signal manager 1035 is capable of, configured to, or operable to support a means for outputting a back-scattered signal including identification information associated with the EH-capable device and the enrichment information.

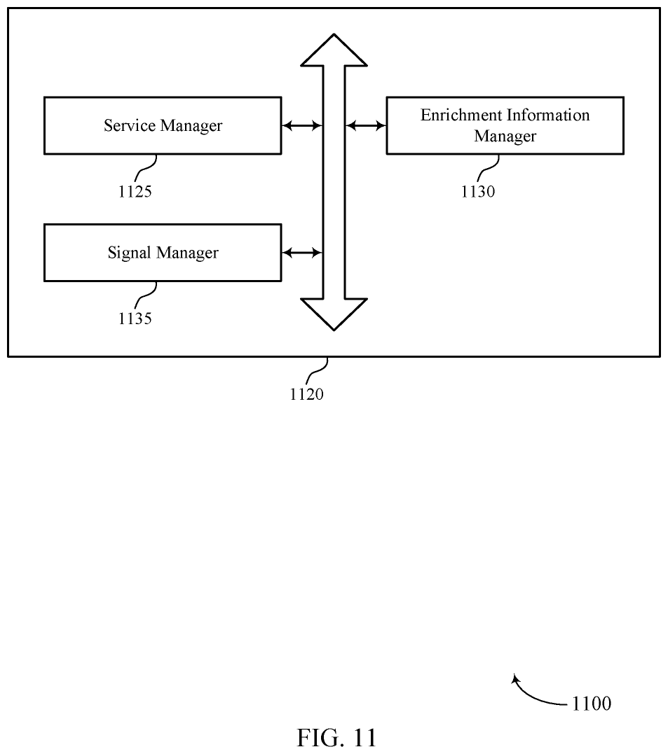

FIG. 11 shows a block diagram 1100 of a communications manager 1120 that supports AIoT system architecture in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of AIoT system architecture as described herein. For example, the communications manager 1120 may include a service manager 1125, an enrichment information manager 1130, a signal manager 1135, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The service manager 1125 is capable of, configured to, or operable to support a means for enabling, based on detection of a first signal from a network entity, a service associated with the EH-capable device. The enrichment information manager 1130 is capable of, configured to, or operable to support a means for obtaining enrichment information associated with the service. The signal manager 1135 is capable of, configured to, or operable to support a means for outputting a back-scattered signal including identification information associated with the EH-capable device and the enrichment information.

In some aspects, the identification information, the enrichment information, or both are encoded.

In some aspects, generating the enrichment information includes collecting, using a sensor at the EH-capable device, the enrichment information. In some aspects, the enrichment information includes sensor information.

In some aspects, the sensor information includes location information, environmental information, or a combination thereof.

In some aspects, the enrichment information includes device status information or neighbor cell information.

In some aspects, the EH-capable device is a low power device without energy storage capabilities.

In some aspects, the EH-capable device is a low power device without 3GPP protocol stack capabilities.

In some aspects, the EH-capable device is a low power device without SIM credentials.

In some aspects, the first signal includes an energy signal received from the network entity for energy harvesting.

In some aspects, the back-scattered signal is output using radio resources shared across a set of multiple MNOs.

In some aspects, the back-scattered signal is output using dedicated radio resources associated with a first MNO of a set of multiple MNOs.

In some aspects, the EH-capable device includes a RFID tag.

In some aspects, the identification information includes a tag ID associated with the RFID tag.

In some aspects, the network entity includes a base station, one or more components of a base station, or a UE.

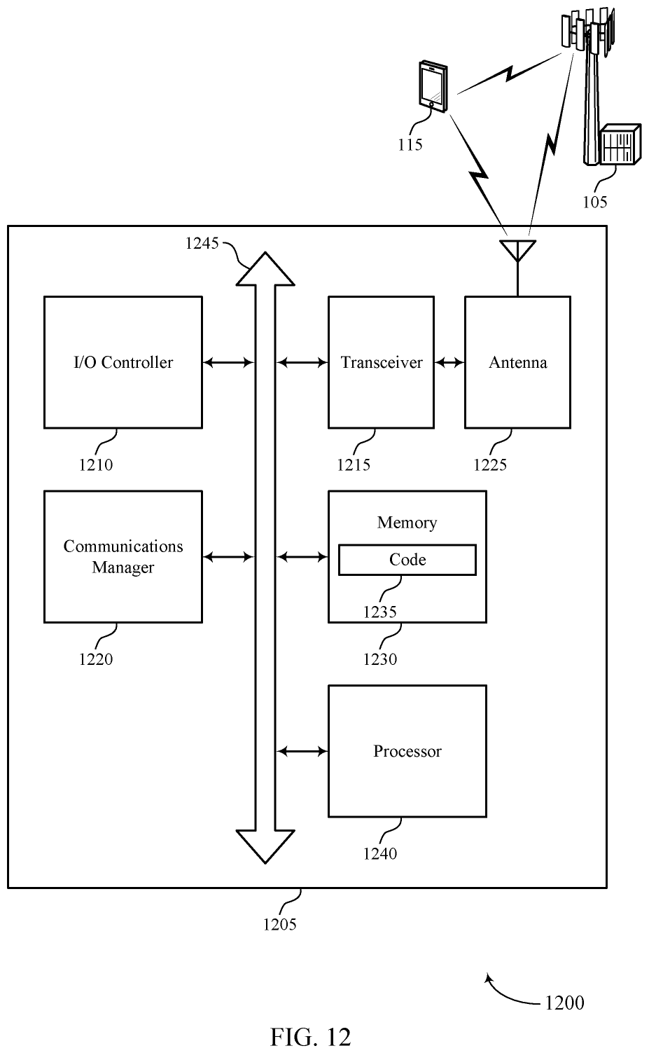

FIG. 12 shows a diagram of a system 1200 including a device 1205 that supports AIoT system architecture in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting AIoT system architecture). For example, the device 1205 or a component of the device 1205 may include at least one processor 1240 and at least one memory 1230 coupled with or to the at least one processor 1240, the at least one processor 1240 and the at least one memory 1230 configured to perform various functions described herein. In some aspects, the at least one processor 1240 may include multiple processors and the at least one memory 1230 may include multiple memories. One or more of the multiple processors may be coupled with one or more of the multiple memories, which may, individually or collectively, be configured to perform various functions described herein. In some aspects, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for enabling, based on detection of a first signal from a network entity, a service associated with the EH-capable device. The communications manager 1220 is capable of, configured to, or operable to support a means for obtaining enrichment information associated with the service. The communications manager 1220 is capable of, configured to, or operable to support a means for outputting a back-scattered signal including identification information associated with the EH-capable device and the enrichment information.

By including or configuring the communications manager 1220 in accordance with examples as described herein, the device 1205 may support techniques for improved communication reliability, more efficient utilization of communication resources, improved coordination between devices, and improved utilization of processing capability.

In some aspects, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some aspects, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of AIoT system architecture as described herein, or the at least one processor 1240 and the at least one memory 1230 may be otherwise configured to, individually or collectively, perform or support such operations.

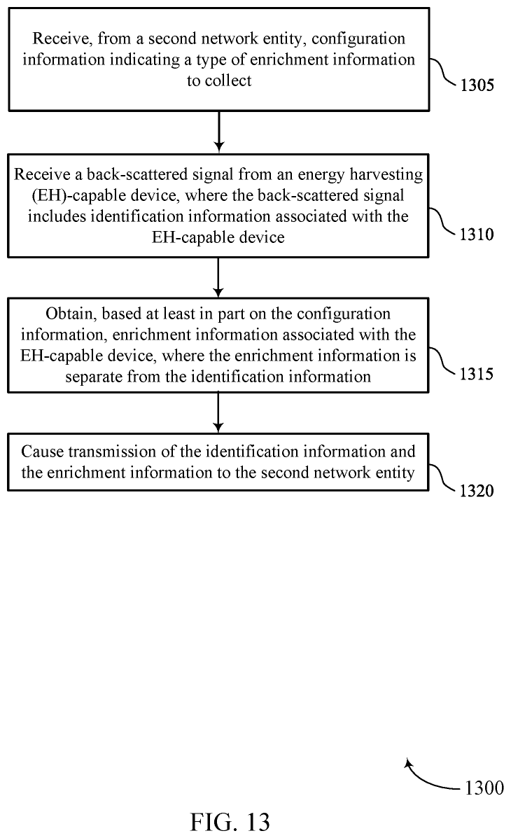

FIG. 13 shows a flowchart illustrating a method 1300 that supports an AIoT system architecture in accordance with one or more aspects of the present disclosure. The operations of the method 1300 may be implemented by a network entity or its components as described herein. For example, the operations of the method 1300 may be performed by a network entity as described with reference to FIGS. 1 through 8. In some aspects, a network entity may execute a set of instructions to control the functional elements of the network entity to perform the described functions. Additionally, or alternatively, the network entity may perform aspects of the described functions using special-purpose hardware.

At 1305, the method may include receiving, from a second network entity, configuration information indicating a type of enrichment information to collect. The operations of 1305 may be performed in accordance with examples as disclosed herein. In some examples, aspects of the operations of 1305 may be performed by an enrichment information manager 730 as described with reference to FIG. 7.

At 1310, the method may include receiving a back-scattered signal from an EH-capable device, where the back-scattered signal includes identification information associated with the EH-capable device. The operations of 1310 may be performed in accordance with examples as disclosed herein. In some examples, aspects of the operations of 1310 may be performed by a signal manager 725 as described with reference to FIG. 7.

At 1315, the method may include obtaining enrichment information associated with the EH-capable device, where the enrichment information is separate from the identification information. The operations of 1315 may be performed in accordance with examples as disclosed herein. In some examples, aspects of the operations of 1315 may be performed by an enrichment information manager 730 as described with reference to FIG. 7.

At 1320, the method may include causing transmission of the identification information and the enrichment information to the second network entity. The operations of 1320 may be performed in accordance with examples as disclosed herein. In some examples, aspects of the operations of 1320 may be performed by an information transmission manager 735 as described with reference to FIG. 7.

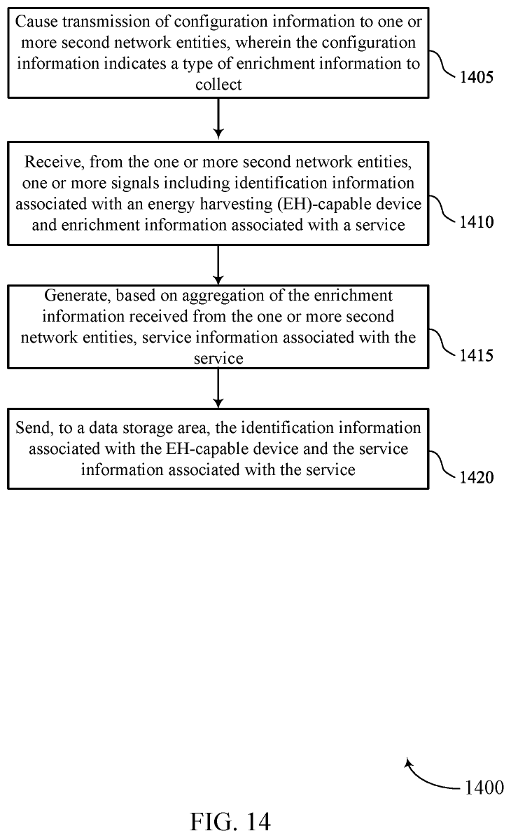

FIG. 14 shows a flowchart illustrating a method 1400 that supports an AIoT system architecture in accordance with one or more aspects of the present disclosure. The operations of the method 1400 may be implemented by a network entity or its components as described herein. For example, the operations of the method 1400 may be performed by a network entity as described with reference to FIGS. 1 through 8. In some aspects, a network entity may execute a set of instructions to control the functional elements of the network entity to perform the described functions. Additionally, or alternatively, the network entity may perform aspects of the described functions using special-purpose hardware.

At 1405, the method may include causing transmission of configuration information to one or more second network entities, wherein the configuration information indicates a type of enrichment information to collect The operations of 1405 may be performed in accordance with examples as disclosed herein. In some examples, aspects of the operations of 1405 may be performed by a enrichment information manager 730 as described with reference to FIG. 7.

At 1410, the method may include receiving, from one or more second network entities, one or more signals including identification information associated with an EH-capable device and enrichment information associated with a service. The operations of 1410 may be performed in accordance with examples as disclosed herein. In some examples, aspects of the operations of 1410 may be performed by a signal manager 725 as described with reference to FIG. 7.

At 1415, the method may include generating, based on aggregation of the enrichment information received from the one or more second network entities, service information associated with the service. The operations of 1415 may be performed in accordance with examples as disclosed herein. In some examples, aspects of the operations of 1415 may be performed by a service information manager 740 as described with reference to FIG. 7.

At 1420, the method may include sending, to a data storage area, the identification information associated with the EH-capable device and the service information associated with the service. The operations of 1420 may be performed in accordance with examples as disclosed herein. In some examples, aspects of the operations of 1420 may be performed by an information transmission manager 735 as described with reference to FIG. 7.

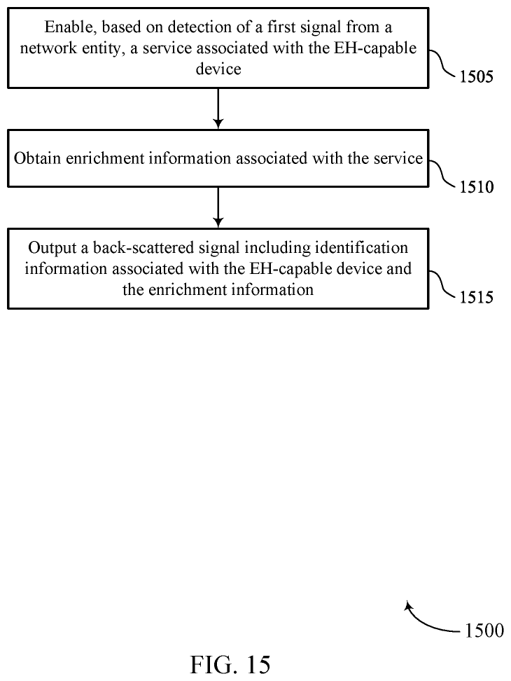

FIG. 15 shows a flowchart illustrating a method 1500 that supports an AIoT system architecture in accordance with one or more aspects of the present disclosure. The operations of the method 1500 may be implemented by a UE or its components as described herein. For example, the operations of the method 1500 may be performed by a UE 115 as described with reference to FIGS. 1 through 4 and 9 through 12. In some aspects, a UE may execute a set of instructions to control the functional elements of the UE to perform the described functions. Additionally, or alternatively, the UE may perform aspects of the described functions using special-purpose hardware.

At 1505, the method may include enabling, based on detection of a first signal from a network entity, a service associated with the EH-capable device. The operations of 1505 may be performed in accordance with examples as disclosed herein. In some examples, aspects of the operations of 1505 may be performed by a service manager 1125 as described with reference to FIG. 11.

At 1510, the method may include obtaining enrichment information associated with the service. The operations of 1510 may be performed in accordance with examples as disclosed herein. In some examples, aspects of the operations of 1510 may be performed by an enrichment information manager 1130 as described with reference to FIG. 11.

At 1515, the method may include outputting a back-scattered signal including identification information associated with the EH-capable device and the enrichment information. The operations of 1515 may be performed in accordance with examples as disclosed herein. In some examples, aspects of the operations of 1515 may be performed by a signal manager 1135 as described with reference to FIG. 11.

The following provides an overview of aspects of the present disclosure:

Aspect 1: A method for wireless communications by a first network entity, comprising: receiving, from a second network entity, configuration information indicating a type of enrichment information to collect; receiving a back-scattered signal from an EH-capable device, wherein the back-scattered signal includes identification information associated with the EH-capable device; obtaining, based at least in part on the configuration information, enrichment information associated with the EH-capable device, wherein the enrichment information is separate from the identification information; and causing transmission of the identification information and the enrichment information to the second network entity.

Aspect 2: The method of aspect 1, wherein obtaining the enrichment information comprises receiving the enrichment information via the back-scattered signal.

Aspect 3: The method of any of aspects 1 through 2, wherein obtaining the enrichment information comprises generating, based on configuration by the second network entity, the enrichment information.

Aspect 4: The method of aspect 3, wherein generating the enrichment information comprises collecting, using a sensor at the EH-capable device, the enrichment information, the enrichment information comprises sensor information.

Aspect 5: The first network entity of any of aspects 1 through 4, wherein the enrichment information comprises device status information or neighbor cell information.

Aspect 6: The method of any of aspects 1 through 5, further comprising: cause transmission of a first signal to the EH-capable device, wherein the first signal comprises an energy signal for energy harvesting, and wherein the back-scattered signal is received in response to the first signal.

Aspect 7: The method of any of aspects 1 through 6, wherein the first network entity comprises a base station, one or more components of a base station, or a UE.

Aspect 8: A method for wireless communications by a first network entity, comprising: causing transmission of configuration information to one or more second network entities, wherein the configuration information indicates a type of enrichment information to collect; receiving, from the one or more second network entities, one or more signals including identification information associated with an energy harvesting (EH)-capable device and enrichment information associated with a service; generating, based at least in part on aggregation of the enrichment information received from the one or more second network entities, service information associated with the service; and sending, to a data storage area, the identification information associated with the EH-capable device and the service information associated with the service.

Aspect 9: The method of aspect 8, wherein the data storage area comprises a data clearinghouse shared by a plurality of PLMNs.

Aspect 10: The method of any of aspects 8 through 9, wherein the first network entity is associated with an MNO or a PLMN.

Aspect 11: The method of any of aspects 8 through 10, further comprising: receiving, from an application function, a request for information associated with a first EH-capable device, wherein the request includes identification information associated with the first EH-capable device; and sending, to the application function and based on the identification information associated with the first EH-capable device, service information associated with the first EH-capable device.

Aspect 12: The method of aspect 11, further comprising: sending, to the application function, a charging record for the service information associated with the first EH-capable device.

Aspect 13: The method of any of aspects 8 through 12, further comprising: tagging service information as unclaimed based on a determination that no request for the service information has been received within a threshold period of time from receipt of the service information from the one or more second network entities.

Aspect 14: The method of aspect 13, further comprising: causing unclaimed service information and corresponding identification information to be removed from the data storage area after the threshold period of time.

Aspect 15: The method of any of aspects 8 through 14, wherein sending the identification information and the service information to the data storage area comprises: identifying the data storage area from among a plurality of data storage areas based at least in part of a type of the service information, routing information associated with the identification information, a location indicated by the service information, a contracted PLMN associated with the data storage area, or a service level agreement associated with a PLMN associated with the data storage area; and sending the identification information and the service information to the identified data storage area.

Aspect 16: A method for wireless communications by an energy harvesting (EH)-capable device, comprising: enabling, based at least in part on detection of a first signal from a network entity, a service associated with the EH-capable device; obtaining enrichment information associated with the service; and outputting a back-scattered signal comprising identification information associated with the EH-capable device and the enrichment information.

Aspect 17: The method of aspect 16, wherein obtaining the enrichment information comprises collecting, using a sensor at the EH-capable device, the enrichment information, the enrichment information comprises sensor information, and the sensor information comprises location information or environmental information.

Aspect 18: The method of any of aspects 16 through 17, wherein the first signal comprises an energy signal received from the network entity for energy harvesting.

Aspect 19: The method of any of aspects 16 through 18, wherein the back-scattered signal is output using radio resources shared across a plurality of mobile network operators (MNOs) or dedicated radio resources associated with a first MNO of a plurality of MNOs.

Aspect 20: The method of any of aspects 16 through 19, wherein the EH-capable device comprises a RFID tag.

Aspect 21: A first network entity for wireless communications, comprising one or more memories storing processor-executable code, and one or more processors coupled with the one or more memories and individually or collectively operable to execute the code to cause the first network entity to perform a method of any of aspects 1 through 7.

Aspect 22: A first network entity for wireless communications, comprising at least one means for performing a method of any of aspects 1 through 7.

Aspect 23: A non-transitory computer-readable medium storing code for wireless communications, the code comprising instructions executable by one or more processors to perform a method of any of aspects 1 through 7.

Aspect 24: A first network entity for wireless communications, comprising one or more memories storing processor-executable code, and one or more processors coupled with the one or more memories and individually or collectively operable to execute the code to cause the first network entity to perform a method of any of aspects 8 through 15.

Aspect 25: A first network entity for wireless communications, comprising at least one means for performing a method of any of aspects 8 through 15.

Aspect 26: A non-transitory computer-readable medium storing code for wireless communications, the code comprising instructions executable by one or more processors to perform a method of any of aspects 8 through 15.

Aspect 27: An EH-capable device for wireless communications, comprising one or more memories storing processor-executable code, and one or more processors coupled with the one or more memories and individually or collectively operable to execute the code to cause the EH-capable device to perform a method of any of aspects 16 through 20.

Aspect 28: An EH-capable device for wireless communications, comprising at least one means for performing a method of any of aspects 16 through 20.

Aspect 29: A non-transitory computer-readable medium storing code for wireless communications, the code comprising instructions executable by one or more processors to perform a method of any of aspects 16 through 20.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the aspects and designs described herein but is to be accorded the broadest scope consistent with the principles and novel features disclosed herein.

What is claimed is:

1. A first network entity for wireless communication, comprising:
a processing system configured to:
receive, from a second network entity, configuration information indicating a type of enrichment information to collect;
receive a back-scattered signal from an energy harvesting (EH)-capable device, wherein the back-scattered signal includes identification information associated with the EH-capable device;
obtain, based at least in part on the configuration information, enrichment information associated with the EH-capable device, wherein the enrichment information is separate from the identification information; and
cause transmission of the identification information and the enrichment information to the second network entity.

2. The first network entity of claim 1, wherein, to obtain the enrichment information, the processing system is configured to:
receive the enrichment information via the back-scattered signal.

3. The first network entity of claim 1, wherein, to obtain the enrichment information, the processing system is configured to:
generate, based on configuration by the second network entity, the enrichment information.

4. The first network entity of claim 3, wherein, to generate the enrichment information, the processing system is configured to:
collect, using a sensor at the EH-capable device, the enrichment information, wherein the enrichment information comprises sensor information.

5. The first network entity of claim 1, wherein the enrichment information comprises device status information or neighbor cell information.

6. The first network entity of claim 1, wherein the processing system is configured to:
cause transmission of a first signal to the EH-capable device, wherein the first signal comprises an energy signal for energy harvesting, and wherein the back-scattered signal is received in response to the first signal.

7. The first network entity of claim 1, wherein the first network entity comprises a base station, one or more components of a base station, or a user equipment (UE).

8. A first network entity for wireless communication, comprising:
a processing system configured to:
cause transmission of configuration information to one or more second network entities, wherein the configuration information indicates a type of enrichment information to collect;
receive, from the one or more second network entities, one or more signals including identification information associated with an energy harvesting (EH)-capable device and enrichment information associated with a service;
generate, based on aggregation of the enrichment information received from the one or more second network entities, service information associated with the service; and
send, to a data storage area, the identification information associated with the EH-capable device and the service information associated with the service.

9. The first network entity of claim 8, wherein the data storage area comprises a data clearinghouse shared by a plurality of public land mobile networks (PLMNs).

10. The first network entity of claim 8, wherein the first network entity is associated with a mobile network operator (MNO) or a public land mobile network (PLMN).

11. The first network entity of claim 8, wherein the processing system is configured to:
receive, from an application function, a request for information associated with a first EH-capable device, wherein the request includes identification information associated with the first EH-capable device; and
send, to the application function and based on the identification information associated with the first EH-capable device, service information associated with the first EH-capable device.

12. The first network entity of claim 11, wherein the processing system is configured to:
send, to the application function, a charging record for the service information associated with the first EH-capable device.

13. The first network entity of claim 8, wherein the processing system is configured to:
tag service information as unclaimed based on a determination that no request for the service information has been received within a threshold period of time from receipt of the service information from the one or more second network entities.

14. The first network entity of claim 13, wherein the processing system is configured to:
cause unclaimed service information and corresponding identification information to be removed from the data storage area after the threshold period of time.

15. The first network entity of claim 8, wherein, to send the identification information and the service information to the data storage area, the processing system is configured to:
identify the data storage area from among a plurality of data storage areas based on a type of the service information, routing information associated with the identification information, a location indicated by the service information, a contracted public land mobile network (PLMN) associated with the data storage area, or a service level agreement associated with a PLMN associated with the data storage area; and
send the identification information and the service information to the identified data storage area.

16. An energy-harvesting (EH)-capable device, comprising:
a processing system configured to:
enable, based on detection of a first signal from a network entity, a service associated with the EH-capable device;
obtain enrichment information associated with the service; and
output a back-scattered signal comprising identification information associated with the EH-capable device and the enrichment information.

17. The EH-capable device of claim 16, wherein, to obtain the enrichment information, the processing system is configured to:
collect, using a sensor at the EH-capable device, the enrichment information, wherein the enrichment information comprises sensor information, and wherein the sensor information comprises location information or environmental information.

18. The EH-capable device of claim 16, wherein the first signal comprises an energy signal received from the network entity for energy harvesting.

19. The EH-capable device of claim 16, wherein the back-scattered signal is output using radio resources shared across a plurality of mobile network operators (MNOs) or dedicated radio resources associated with a first MNO of a plurality of MNOs.

20. The EH-capable device of claim 16, wherein the EH-capable device comprises a radio frequency identification (RFID) tag.
